(19) United States
(12) Patent Application Publication
(10) Pub. No.: US 2013/0186193 A1
(43) Pub. Date: Jul. 25, 2013

(54) System and Method for Testing Railroad Brake Control Valves

(71) Applicant: WABCO Freight Car Products, Wilmerding, PA (US)

(72) Inventor: Gary M. Sich, Irwin, PA (US)

(73) Assignee: WABCO Freight Car Products, Wilmerding, PA (US)

(21) Appl. No.: 13/750,136

(22) Filed: Jan. 25, 2013

Related U.S. Application Data
(60) Provisional application No. 61/590,529, filed on Jan. 25, 2012.

(51) Int. Cl. G01L 5/28

(52) U.S. Cl. CPC G01L 5/28
USPC 73/121

(57) ABSTRACT

A system for testing a railroad brake control valve includes an operating portion configured to receive operating information from a railroad brake control valve, a processing portion connected to the operating portion, an adaptor configured to engage a receiver of a pipe bracket, and, an information reader configured to obtain valve identification information from an information source. The processing portion receives the operating information from the operating portion. The adapter is connected to the operating portion.

### CROSS REFERENCE TO RELATED APPLICATIONS

This application claims the benefit of U.S. Provisional Application No. 61/590,529, filed Jan. 25, 2012, the entire content of which is hereby incorporated by reference.

### BACKGROUND OF THE INVENTION

1. Field of the Invention

The present invention relates to railroad brake control valves and, more particularly, to a system and method for testing railroad brake control valves.

2. Description of Related Art

Control valves that control the operation of brakes for railroad freight cars, such as the ABDX control valve sold and manufactured by Wabtec Corporation, include an emergency portion and a service portion that are secured to a pipe bracket. The pipe bracket has an integral receiver, such as a four-port receiver, that accommodates and receives a connection to an Automatic Single Car Test Device (ASCTD). The ASCTD allows the freight car air brakes to be tested to ensure such brakes are operating properly and to diagnose any problems. An automatic brake control valve test unit is disclosed in U.S. Pat. No. 5,509,727, which is hereby incorporated by reference in its entirety.

### SUMMARY OF THE INVENTION

In one embodiment, a system for testing a railroad brake control valve includes an operating portion configured to receive operating information from a railroad brake control valve, a processing portion connected to the operating portion, an adaptor configured to engage a receiver of a pipe bracket, and an information reader configured to obtain valve identification information from an information source. The processing portion receives the operating information from the operating portion. The adapter is connected to the operating portion.

The system may further include a source of compressed air that is connected to the operating portion. The processing portion may include a microprocessor and a power supply. The processing portion may be configured to be connected to at least one of a display, a data file, a server, and a central database. The processing portion may also be connected to a remote database via an internet connection. The information reader may be integrated into the adapter. The processing portion may include a microprocessor with the information reader being connected to the microprocessor. The information reader may be at least one of a bar code reader and an RFID tag reader.

In a further embodiment, a method for testing a railroad brake control valve includes: connecting an adaptor from a test device to a receiver of a pipe bracket of a railroad brake control valve; obtaining identification information for the railroad brake control valve from an information source using an information reader; conducting a test of the railroad brake control valve using a microprocessor; and, notifying a designated person of a status of the railroad brake control valve. The status is determined by the test conducted of the railroad brake control valve.

In one embodiment, the status may be a pass/fail condition. The designated person may be notified via an electronic message. The information source may be at least one of a bar code tag and an RFID tag. The identification information may be obtained automatically upon connecting the adaptor to the receiver of the pipe bracket. The method may also further include: removing a defective portion of the railroad brake control valve based on the status of the railroad brake control valve; obtaining identification information for the defective portion of the railroad brake control valve; and, notifying the designated person that the defective portion has been identified for repair. The method may also include determining a warranty status of the defective portion using a microprocessor; notifying the designated person of the warranty status of the defective portion; and, notifying the designated person of shipping information for the defective part. Further, the method may include sending an invoice to the designated person based on the warranty status of the defective portion.

### BRIEF DESCRIPTION OF THE DRAWINGS

FIG. 1 is a schematic view of a system for testing a railroad brake control valve according to one embodiment of the present invention.

FIG. 2 is a perspective view of a pipe brake according to one embodiment of the present invention.

FIG. 3 is a flow chart illustrating a method of testing a railroad brake control valve according to one embodiment of the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, and derivatives thereof, shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

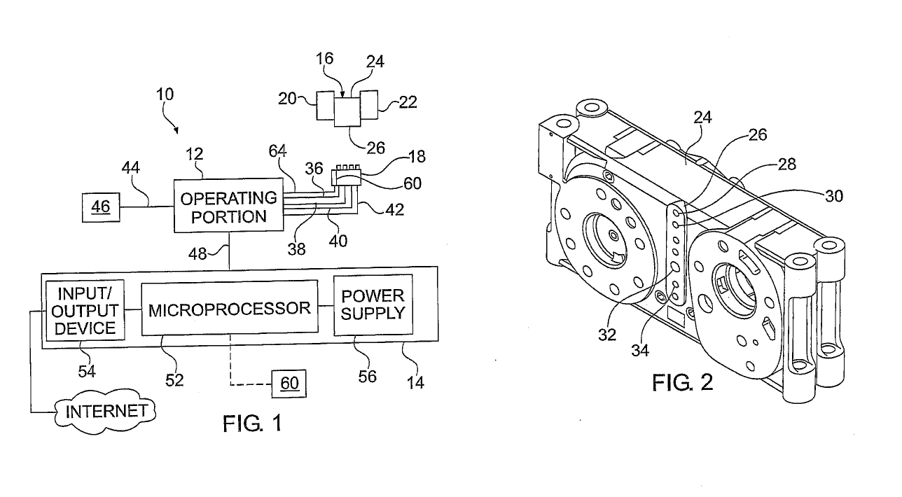

Referring to FIGS. 1 and 2, one embodiment of a system 10 for testing a railroad brake control valve includes an operating portion 12 and a processing portion 14 that from an ASCTD. The operating portion 12 is connected to a control valve 16 via an adapter 18. In particular, the control valve 16 includes an emergency portion 20 and a service portion 22 that are attached to a pipe bracket 24, although other types and arrangements of control valves 16 may also be utilized. The pipe bracket 24 includes a receiver 26, such as a 4-port receiver, that includes an emergency reservoir port 28, an auxiliary reservoir port 30, a brake pipe port 32, and a brake cylinder port 34 that are connected to the fluid passageways of the emergency reservoir, auxiliary reservoir, brake pipe, and brake cylinder, respectively. Although a single sided pipe bracket is shown, other types and arrangements for the pipe bracket 24 may be utilized. The adapter 18 engages and is received by the receiver 26 of the pipe bracket 24. The adapter 18 includes first, second, third, and fourth pneumatic hoses 36, 38, 40, 42 that are placed in fluid communication with the emergency reservoir port 28, the auxiliary reservoir port 30, the brake pipe port 32, and the brake cylinder port 34, respectively. An air supply hose 44 connects a source of compressed air 46, such as an air compressor, to the operating portion 12. The operating portion 12 is connected to the processing portion 14 by an electrical cable 48, although other suitable connections may also be utilized. The operating portion 12 utilizes a plurality of electro-pneumatic control valves and the compressed air from the compressed air source 46 to test the various functions of the control valve 16 to ensure the valve is operating properly.

Referring to FIG. 1, the processing portion 14 includes a microprocessor 52 connected to an input/output device 54 and to a power supply 56. The microprocessor 52, which is connected to the operating portion 12, calculates and stores various information and values received from valves, transducers, flow meters, and other components of the operating portion 12. In particular, the microprocessor 52 may calculate and store various pressures, differences in certain pressures, the rate of change of certain pressures, elapsed times, and flow readings. The microprocessor 52 analyzes and compares such values to evaluate the operating condition of the control valve 16. The results of such analysis and comparison can be stored and outputted via the input/output device 54.

Referring again to FIGS. 1 and 2, an information reader 60, such as an RFID tag reader or bar code scanner, is incorporated into the adapter 18 of the system 10. Further, as shown in FIG. 2, an information source 62, such as a bar code or RFID tag, is provided on or adjacent to the receiver 26 of the pipe bracket 24. The information source 62 stores identification information about the control valve 16 to which it is attached. The information may be added to the information source 62 at the time the control valve 16 is manufactured. Such information may include the manufacturer, part number for the control valve, control valve replacement portion part number, date of manufacture, warranty date, or any other suitable information. At the time of mounting the control valve 16 to a rail car, the rail car manufacturer may add additional information such as the car owner, car number, date the rail car was manufactured, the date of the last single car test, or any other suitable information. Additional information on other car components, such as empty/load devices, retainers, vent valves, etc., may also be provided on the information source 62. The information reader 60 is connected to the microprocessor 52 or an additional microprocessor and is configured to read information from the information source 62 and send such information to the microprocessor 52.

Referring to FIG. 1, the information reader 60 may be electronically connected to the operating portion 12 via a cable 64 and from the operating portion 12 to the microprocessor 52 via an electrical cable 48. The information reader 60, however, may be directly connected to the microprocessor 52, wirelessly connected to the microprocessor 52, or otherwise connected to a microprocessor 52 to allow the transfer of information received by the information reader 60. In particular, the information reader 60 is configured to read the information source 62 and convey the information stored to the information source 62 to a display, a data file for the single car test being run, a server, and/or a central database. The processing portion 14 may be connected, through a wired or wireless connection, to the internet to allow the transmission of information from the information reader 60 and operating portion 12 to a display, a data file for the single car test being run, a server, and/or a central database. The system 10 may also be directly connected to a display, a data file, a server, and/or a central database, either wired or wirelessly, rather than connecting through an internet connection to the internet.

Although the information source 62 may include a variety of information as discussed above, the information source 62 may also just provide an identifier for the railroad control valve 16 and with that identifier being used to obtain or provide further information from or to a data file, server, and/or central database. The information reader 60 may automatically read the information source 62 whenever the adaptor 18 for the system 10 is connected to the control valve 16 to run a single car test and automatically enter the information into the data file for the test being run by the system 10. The system 10 may also facilitate the automated ordering of replacement components.

Moreover, the information reader 60 may also be provided separately from the adaptor 18 for the system 10. In particular, the information reader 60 may be embodied as a handheld device provided separately from the system 10. The operation of the information reader 60 may be integrated into the operation of the system 10, but may also be functional separately from the system 10. If there is no testing system 10 present, the information reader 60 may store the information from the information source 62 on the information reader 60 or wirelessly transmit or link to a database/program that receives the information from the information reader 60. Furthermore, the information source 62, such as the bar code or RFID tag, may be located at any suitable position on the control valve 16 rather than being located adjacent to the receiver 26 of the pipe bracket 24. The information source 62 may be located on a specific portion of the control valve 16, such as a service portion or emergency portion, or may be provided on other, separate brake system components, such as empty/load devices. Moreover, a plurality of information sources 62 may also be provided, such that an information source 62 is provided separately for various portions of the control valve 16 and/or other brake system components.

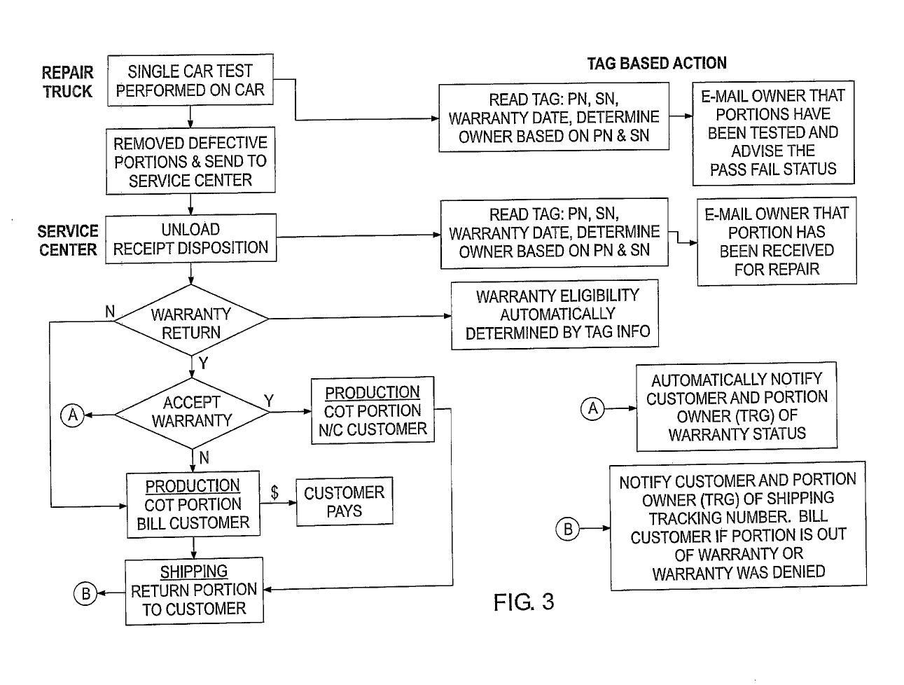

Referring to FIG. 3, one embodiment of a method for testing and servicing railroad brake control valves includes connecting the adaptor 18 for the system 10 described above to the receiver 26 on the control valve pipe bracket 24 and automatically reading the information source 62, such as an RFID or bar code tag, to obtain the part number, serial number, and warranty information. A designated person or persons, such as an owner or customer, of the control valve 16 is then determined based on the part number and serial number information. A single car test is performed by the system 10 on the railroad brake control valve 16. After performing the single car test, the designated person may be automatically notified, such as through an electronic message or mail, advising the designated person of a pass/fail status of the control valve 16. Alternatively, as noted above, the information reader 60 may be used to read the information source 62, such as a RFID tag or bar code tag, and the information reader 60 may cooperate with the system 10 or transmit the information to a separate data file, a server, and/or a central database that is local or remote from the system. Any portions of the control valve 16 that were determined to be defective by the system 10 are removed and sent to a service center. After sending the defective part to a service center, an information source 62 attached to a portion of the control valve 16 or another brake component is read to determine the warranty status and designated person, who may be automatically notified, via an electronic message or mail, that the defective portion has been received for repair. The warranty status, such as the warranty eligibility, for the defective part or portion is automatically determined by the information provided by the information source 62 or tag. If the part or portion is eligible for warranty, the designated person may be automatically notified of the warranty status. If the part or portion is not eligible for warranty, the designated person may be automatically notified of the status and provided with the shipping tracking number as well as billing information. Thus, an invoice and other billing information may be automatically sent to the designated person or persons based on the warranty status of the defective portion.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions, or other type of instructions capable of being executed by the computing or processing device may include, but may not be limited to, one or more of a CD-ROM, DVD, memory, hard disk, flash drive, RAM, ROM, cache and the like.

The methods and/or processes described above, and steps thereof, may be realized in hardware, software, or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the description. For example, it is to be understood that the present invention contemplates that, to the extent possible, one or more features of any embodiment can be combined with one or more features of any other embodiment.

The invention claimed is:

1. A system for testing a railroad brake control valve, the system comprising:
an operating portion configured to receive operating information from a railroad brake control valve;
a processing portion connected to the operating portion, the processing portion receiving the operating information from the operating portion;
an adaptor configured to engage a receiver of a pipe bracket, the adapter is connected to the operating portion; and
an information reader configured to obtain valve identification information from an information source.

2. The system of claim 1, wherein the system further comprises a source of compressed air that is connected to the operating portion.

3. The system of claim 1, wherein the processing portion comprises a microprocessor and a power supply.

4. The system of claim 3, wherein the processing portion is configured to be connected to at least one of a display, a data file, a server, and a central database.

5. The system of claim 4, wherein the processing portion is configured to be connected to a remote database via an internet connection.

6. The system of claim 1, wherein the information reader is integrated into the adapter.

7. The system of claim 6, wherein the processing portion comprises a microprocessor, the information reader is connected to the microprocessor.

8. The system of claim 7, wherein the processing portion is configured to be connected to at least one of a display, a data file, a server, and a central database.

9. The system of claim 1, wherein the information reader comprises at least one of a bar code reader and an RFID tag reader.

10. The system of claim 6, wherein the information reader comprises at least one of a bar code reader and an RFID tag reader.

11. A method for testing a railroad brake control valve, the method comprising:
connecting an adaptor from a test device to a receiver of a pipe bracket of a railroad brake control valve;
obtaining identification information for the railroad brake control valve from an information source using an information reader;
conducting a test of the railroad brake control valve using a microprocessor; and
notifying a designated person of a status of the railroad brake control valve, the status determined by the test conducted of the railroad brake control valve.

12. The method of claim 11, wherein the status comprises a pass/fail condition.

13. The method of claim 12, wherein the designated person is notified via an electronic message.

14. The method of claim 11, wherein the information source comprises at least one of a bar code tag and an RFID tag.

15. The method of claim 14, wherein the identification information is obtained automatically upon connecting the adaptor to the receiver of the pipe bracket.

16. The method of claim 11, further comprising:
removing a defective portion of the railroad brake control valve based on the status of the railroad brake control valve;
obtaining identification information for the defective portion of the railroad brake control valve; and
notifying the designated person that the defective portion has been identified for repair.

17. The method of claim 16, further comprising determining a warranty status of the defective portion using a microprocessor.

18. The method of claim 17, further comprising notifying the designated person of the warranty status of the defective portion.

19. The method of claim 17, further comprising notifying the designated person of shipping information for the defective part.

20. The method of claim 19, further comprising sending an invoice to the designated person based on the warranty status of the defective portion.
